(19) United States
(12) Patent Application Publication
(10) Pub. No.: US 2005/0010645 A1
(43) Pub. Date: Jan. 13, 2005

(54) Additive and substractive messaging

(76) Inventors: Taymoor Arshi, Portland, OR (US); Terry Downs, Portland, OR (US); Allison Pappas, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/608,917

(22) Filed: Jun. 26, 2003

(51) Int. Cl. G06F 15/16

(52) U.S. Cl. 709/207

(57) ABSTRACT

Additive and subtractive message is performed based in least in part on an intersection of various distribution lists to determine, if only temporarily, a new distribution list for a message. A particular distribution list may respectively be combined or intersected with an additive or a subtractive distribution list. Thus, for example, an e-mail message may be addressed to a distribution list for all employees, but where a subtractive list is applied to remove certain employees from receiving the e-mail message. The distribution list for all employees need not be altered.

### FIELD OF THE INVENTION

The invention generally relates to data distribution lists, and more particularly to intersecting a distribution list with an exclusion list to determine a temporarily modified distribution list used to distribute data.

### BACKGROUND

As time passes, increasing numbers of people and machines obtain access to the Internet or other network to allow the people or machines to easily exchange data with other people and/or machines. A side-effect of the increasing number of potential data recipients is the difficultly in coordinating data delivery to a wide audience, e.g., a large number of recipients. Towards this end, distribution lists, or “mailing lists” in an electronic document context such as E-mail, have been developed to facilitate grouping and tracking recipients.

Creating distribution lists is often a tedious and/or complex manual task, since there may be many list members requiring processing for entry on to the list. Further, in some circumstances, such as in advanced environments, a list may be automatically defined based on characteristics of an environment, e.g., a “customers” list may refer to all customers of a computing system. However, regardless of how the list is created, on occasion it may be useful to send data to only some members of a particular distribution list, rather than all members or class of members of the list. Similarly, it may be useful to aggregate several distribution lists which may have been manually or automatically determined, and then exclude some members or class of members from the combination of lists. Since member(s) to exclude from distribution lists or combinations thereof may vary each time an exclusion is performed, performing such an exclusion is not available with current distribution list technology.

### BRIEF DESCRIPTION OF THE DRAWINGS

The features and advantages of the present invention will become apparent from the following detailed description of the present invention in which:

FIG. 1 illustrates modification of a mailing list according to one embodiment.

FIG. 2 illustrates according to one embodiment a variation of FIG. 1.

FIG. 3 illustrates according to one embodiment a variation of FIG. 2.

FIG. 4 illustrates a system of machines according to one embodiment that may implement the principles discussed above for FIG. 1.

FIG. 5 illustrates according to one embodiment a variation of FIG. 4.

FIG. 6 illustrates according to one embodiment peer devices in which a peer manipulates a mailing list to send a message to other peer devices.

FIG. 7 illustrates a suitable computing environment in which certain aspects of the invention may be implemented.

### DETAILED DESCRIPTION

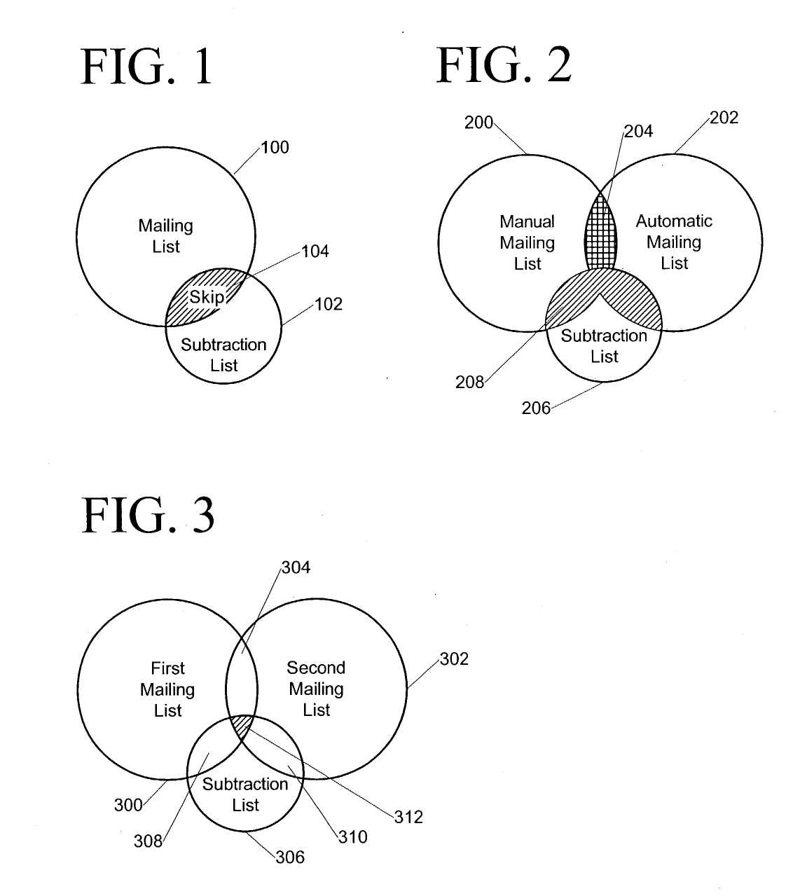

FIG. 1 illustrates modification of a mailing list according to one embodiment. Illustrated is a mailing list 100, such as a manually created mailing list for a particular group of people, or an automatically defined list, such as one determined with respect to a category of people or machines, such as people working at a particular facility, in a certain business unit or group, in a certain technology area, newly hired personnel, etc. The illustrated mailing list may be used, for example, by an electronic document distribution program such as an e-mail application program that determines to whom to distribute a particular message and/or associated data. In the claims and description that follows, usage of the term “list,” may reference, unless context requires otherwise, lists identifying people and/or machines.

Illustrated is a subtraction list 102 which, in the illustrated embodiment, is used to identify a portion 104 of the mailing list 100 that should be skipped when a message is addressed to the mailing list. Thus, for example, assume a user of an electronic document distribution program, such as an “e-mail” program or other application that allows distributing data to one or more addressees, where an addressee may be a single recipient or a mailing list identifying multiple recipients. Assume further that it is desirable to distribute a message to all but a few members of the mailing list, such as to send out a surprise birthday notification to all list members except those having the birthdays that are the subject of the surprise, or to staff members except for the boss/head staff member.

Rather than being required to manually create a special list including only those members not having a birthday, instead, as illustrated, the subtraction list 102 may be defined to include the members having birthdays. A message may then be addressed to the mailing list, which includes the members having birthdays, along with identification of the subtraction list to prevent their receiving the birthday notification. It will be appreciated that various techniques may be applied to implement the subtraction list. For example, in an e-mail application program, just as there are TO, CC, BCC, etc. address fields, one may implement ADD and SUB fields to allow identifying one or more additive (not illustrated) or subtractive lists 102 to modify addressed recipients.

Alternatively, some sort of set notation may be used in the address fields to indicate additive or subtractive mailing lists. For example, a minus symbol “−” may be used to identify a subtractive operation, while a plus symbol “+” may be used to identify an additive operation. It will be appreciated that various manual and automatic mailing lists may be combined, and therefore there may be conflicts between the lists, e.g., an additive list may identify a member also identified in a subtractive list. It will be appreciated that various local policies may be applied to determine how to resolve conflicts; for simplicity it may be assumed a subtractive list overcomes an additive one.

It will be appreciated by one skilled in the art, that adjusting mailing lists is presented for exemplary purposes only, and that the disclosed additive and subtractive principles may be applied to other data distributions as well. In addition, it will be appreciated the illustrated embodiments may be applied at a high level, such as by an application program as discussed above, or at a low-level, such as for determining packet distribution in, for example, a broadcast or simulcast to multiple recipients.

FIG. 2 illustrates according to one embodiment a variation of FIG. 1. As illustrated, instead of a single mailing list 100 as in FIG. 1, instead there are two mailing lists, a first manual mailing list 200, such as one that might be manually created by a manager to track group membership, and a second automatic mailing list 202, such as one that might be automatically created based on a characteristic or feature of potential list members, e.g., a list of current evening-shift employees. Note a pictorial notation is applied herein where a depicted overlapping of mailing lists 200, 203 includes an implied additive aggregation of the depicted lists, e.g., Manual Mailing List 200+ Automatic Mailing List 202, and the lists may have overlapping membership 204.

Assume data, such as an e-mail message, is addressed for delivery to the members of both the manual and automatic mailing lists 200, 202. As with FIG. 1, a subtraction list 206 is applied to the manual and automatic mailing lists to identify addresses 208 to be removed from either of the two mailing lists. It will be appreciated to one skilled in the art that the subtraction list may be determined automatically, thus allowing defining another automatic mailing list identifying only those member meeting certain desired characteristics. For example, a message may be addressed to an automatic mailing list 202 identifying all employees of a corporation, but where an automatic subtraction list 206 is also defined that identifies all senior management.

FIG. 3 illustrates according to one embodiment a variation on FIG. 2. Although illustrated embodiments are primarily concerned with mailing list manipulations to allow removing or adding members from existing mailing lists, under some circumstances, it may be desirable to apply the subtractive principles to identify certain members that are present in multiple mailing lists.

For example, as illustrated, there are first and second mailing lists 300, 302 having an overlap region 304, e.g., duplicate list members in both mailing lists. Applied to this combination of lists is a subtraction list 306 that overlaps the mailing lists in three areas 308, 310, 312. However, unlike in FIG. 2, rather than subtracting all of overlapping areas from the mailing lists, instead, only the subtraction list members 312 found in both the first and second mailing lists 300, 302 are removed from the mailing. It will be appreciated that the results of the subtraction operation may be inverted, e.g., to allow a message to be delivered to only those list members 312 in both mailing lists.

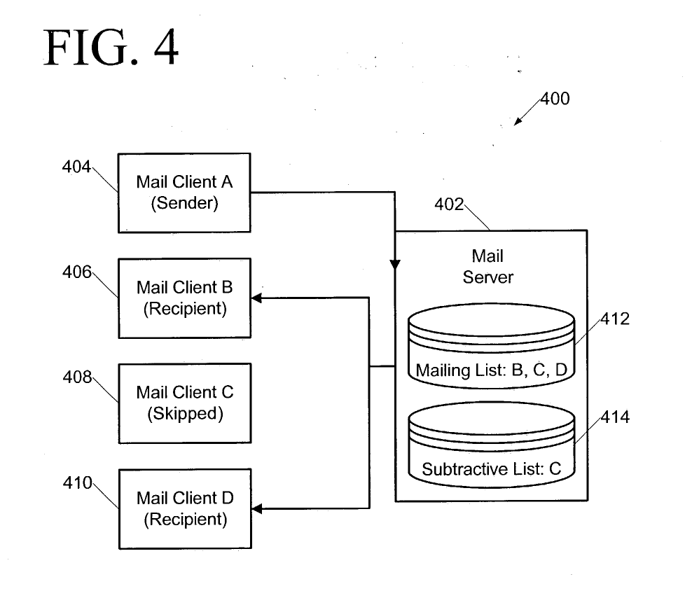

FIG. 4 illustrates a system 400 of machines according to one embodiment that may implement the principles discussed above for FIG. 1. Illustrated are a Mail Server 402, a Mail Client 404 sending mail by way of the Mail Server, and potential mail recipient Mail Clients B, C and D 406-410. The Mail Server 402 has an associated, e.g., internally connected or otherwise communicatively coupled, database,412 for storing, for example, a mailing list(s) identifying distribution to recipients B, C, and D 406-410. Also illustrated is another database 406 for storing, for example, a subtractive list identifying delivery is not currently desired for recipient C 408.

If Mail Client 404 addresses a message to the mailing list 412 and also identifies the subtractive list 414, then as discussed above with respect to FIG. 1, mail will be sent only to Mail Client recipients B and D 406, 410. Mail Client C 408 will be skipped in deliver as requested by Mail Client A.

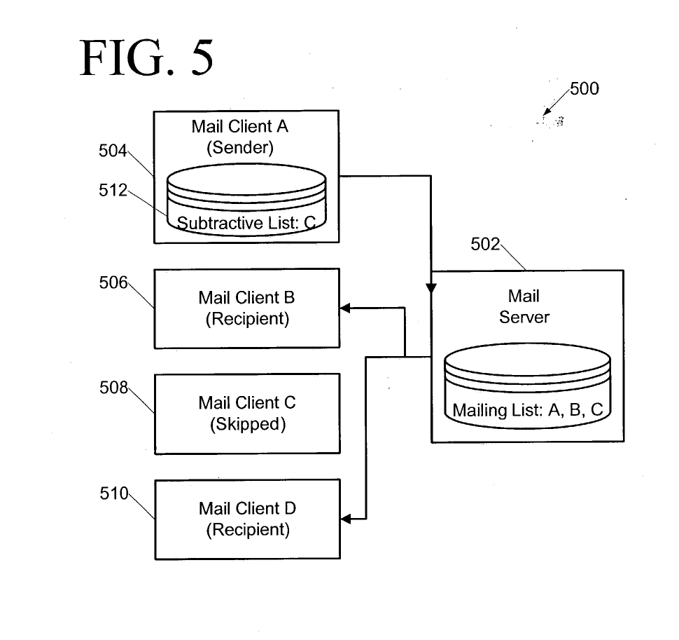

FIG. 5 illustrates according to one embodiment a system 500 variation of FIG. 4. Illustrated are a Mail Server 502, a Mail Client 504 sending mail by way of the Mail Server, and potential mail recipient Mail Clients B, C and D 506-510. Operation is generally the same as discussed above for FIG. 4, except that in this embodiment, instead of a Subtractive List residing on the Mail Server, instead the Subtractive List 512 is associated locally to the Mail Client 504. Thus, in this embodiment, even if a Mail Server does not support subtractive lists, a Mail Client may locally implement subtractive messaging if the client determines mailing list membership and then locally applies the subtractive mailing list to the determined list members.

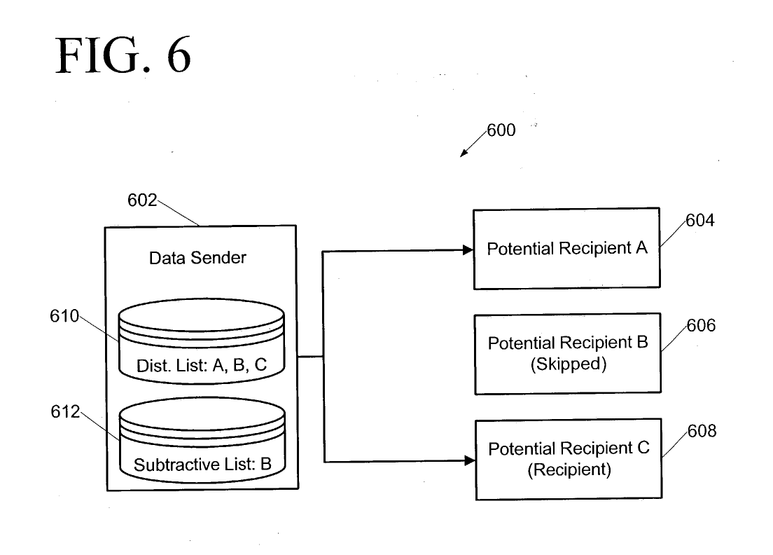

FIG. 6 illustrates according to one embodiment a system 600 of peer devices, e.g., Data Sender 602 and Potential Recipients A, B and C 604-608, in which a peer, the Data Sender 602, manipulates a distribution list 610 identifying Recipients A, B, and C when sending a message to the peer devices 604-608. The data to be sent may be an e-mail transmission or some other data delivery, such as a broadcast to the peer group, but where it is desirable by the Data Sender to exclude one of the peers through use of the subtractive list 612. There may be many reasons for an exclusion, including attempting to exclude malfunctioning, out of date, or misbehaving peers.

In this embodiment, there is no dedicated mail server or other central machine through which communication is channeled. Instead, devices 602-608 are assumed to be employing a peer-to-peer or other decentralized protocol allowing the peers to send and receive messages between themselves. However, when sending data, as illustrated, the Data Sender 602 operates to modify the distribution List 610 to temporarily remove members of the Subtraction List 612 from the data distribution. Thus, only Recipients A and C receive the distribution, since the Subtraction List identifies Recipient B as being excluded. It will be apparent to one skilled in the art, without going into the details herein, that protocol modifications appropriate to a particular transmission environment may be required to effect exclusion.

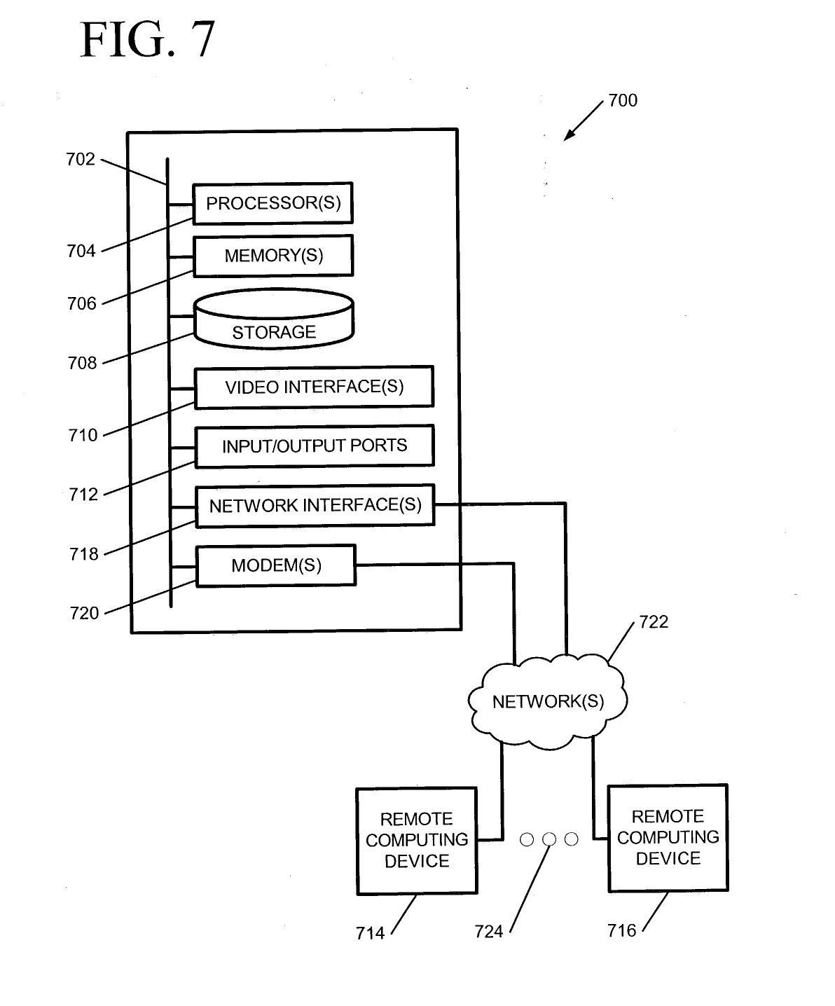

FIG. 7 and the following discussion are intended to provide a brief, general description of a suitable environment in which certain aspects of the illustrated invention may be implemented.

Typically, the environment includes a machine 700. The term “machine” is intended to broadly encompass a single machine, or a system of communicatively coupled machines or devices operating together. Exemplary single machines include computing devices such as personal computers, workstations, servers, portable computers, handheld devices, e.g., Personal Digital Assistant (PDA), telephone, tablets, etc., as well as transportation devices, such as private or public transportation, including automobiles, trains, cabs, etc. The machine 100 may embody various devices, such as a machine attempting to send an e-mail message or perform another data distribution as discussed above with respect to FIGS. 1-4, or the machine 100 may embody the Mail Servers 402, 502 or Mail Clients 404-410, 504-510 of FIGS. 5-6.

Typically within the machine 700 are a system bus 702 to which is attached processors 704, memory 706, e.g., random access memory (RAM), read-only memory (ROM), or other state preserving medium, storage devices 708, a video interface 710, and input/output interface ports 712. The machine may be controlled, at least in part, by input from conventional input devices, such as keyboards, mice, etc., as well as by directives received from another machine, interaction with a virtual reality (VR) environment, biometric feedback, or other input source or signal. It will be appreciated that the machine may have embedded controllers, such as programmable or non-programmable logic devices or arrays, Application Specific Integrated Circuits, embedded computers, smart cards, and the like.

As discussed above with respect to FIGS. 1-6, the machine-is expected to utilize one or more connections to one or more remote machines 714, 716, such as through a network interface 718, modem 720, or other communicative coupling. The ellipses 724 indicate there may be multiple remote machines. Machines may be interconnected by way of a physical and/or logical network 722, such as an intranet, the Internet, local area networks, wide area networks, etc. One skilled in the art will appreciated that communication with network 722 may utilize various wired and/or wireless short range or long range carriers and protocols, including radio frequency (RF), satellite, microwave, Institute of Electrical and Electronics Engineers (IEEE) 802.11, Bluetooth, optical, infrared, cable, laser, etc.

Thus, With respect to FIG. 4, for example, assuming machine 700 embodies the Mail Server 402 of FIG. 4, then the remote machines 714, 724, 716 may respectively be Mail Clients A 404, B 406, C 408, D 410, where as in FIG. 4, Mail Client A seeks to distribute data to a list that temporarily has Mail Client C subtracted therefrom. It will be appreciated that remote machines 714, 724, 716 may be configured like machine 700, and therefore include many or all of the elements discussed for machine.

The invention may be described by reference to or in conjunction with associated data including functions, procedures, data structures, application programs, etc. which when accessed by a machine results in the machine performing tasks or defining abstract data types or low-level hardware contexts. Associated data may be stored in, for example, volatile and/or non-volatile memory 706, or in storage devices 708 and their associated storage media. Associated data may be delivered over transmission environments, including network 722, in the form of packets, serial data, parallel data, propagated signals, etc., and may be used in a compressed or encrypted format. Associated data may be used in a distributed environment, and stored locally and/or remotely for access by single or multi-processor machines.

Having described and illustrated the principles of the invention with reference to illustrated embodiments, it will be recognized that the illustrated embodiments can be modified in arrangement and detail without departing from such principles. And, though the foregoing discussion has focused on particular embodiments, other configurations are contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description is intended to be illustrative only, and should not be taken as limiting the scope of the invention. What is claimed as the invention, therefore, is all such modifications as may come within the scope and spirit of the following claims and equivalents thereto.

1. An electronic-mail (e-mail) method for distributing an e-mail message to selected ones of a pre-determined distribution list, comprising:
addressing the e-mail message to the pre-determined distribution list; and
selecting a subtractive list, which when applied to the pre-determined distribution list, determines a modified distribution list comprising members of the pre-determined distribution list not present in the subtractive list.

2. The method of claim 1, further comprising:
providing the e-mail message to an e-mail server operable to distribute the e-mail message to the modified distribution list.

3. The method of claim 2, wherein the e-mail server is further operable to apply the subtractive list to the pre-determined distribution list to determine the modified distribution list.

4. The method of claim 1 further comprising:
applying the subtractive list to the pre-determined distribution list to determine the modified distribution list; and
distributing the e-mail message to the modified distribution list.

5. The method of claim 1, wherein the e-mail message is distributed via an e-mail server, the method further comprising:
submitting at least an indicator of the pre-determined distribution list and of the subtractive list to the e-mail server so that the e-mail server may determine the modified distribution list; and
receiving from the e-mail server data to facilitate distributing the e-mail message to the modified distribution list.

6. The method of claim 5, further comprising:
receiving from the e-mail server an indicator of the modified distribution list; and
automatically re-addressing the e-mail message to indicator of the modified distribution list, wherein the e-mail server is operable to distribute the e-mail message.

7. The method of claim 1, wherein the distribution list is a selected one of: a manually created list, and an automatically generated list identifying members sharing a common characteristic.

8. The method of claim 1, further comprising:
providing at least an identifier for the pre-determined distribution list and of the subtractive list to a list server operable to apply the subtraction list to the pre-determined distribution list to determine the modified distribution list; and
receiving data from the list server to facilitate performing said distributing the e-mail message to the modified distribution list.

9. The method of claim 5, wherein the distribution server includes an e-mail server functionality.

10. An electronic-mail (e-mail) method for distributing an e-mail message to selected ones of a pre-determined distribution list, comprising:
receiving an e-mail message addressed to a first indicator for a pre-determined distribution list;
receiving a second indicator for a subtractive list, which when applied to the pre-determined distribution list, determines a modified distribution list comprising members of the pre-determined distribution list not present in the subtractive list; and
distributing the e-mail message to each member of the modified distribution list.

11. The method of claim 10, further comprising:
first identifying, based at least in part on the first indicator, the members of the pre-determined distribution list;
second identifying, based at least in part on the second indicator, the members of the subtraction list; and
determining the modified distribution list based at least in part on membership of the pre-determined list and the subtraction list.

12. An article comprising a machine-accessible media having associated data for distributing an e-mail message to selected ones of a pre-determined distribution list, wherein the data, when accessed, results in a machine performing:
addressing the e-mail message to the pre-determined distribution list; and
selecting a subtractive list, which when applied to the pre-determined distribution list, determines a modified distribution list comprising members of the pre-determined distribution list not present in the subtractive list.

13. The article of claim 12 wherein the machine-accessible media further includes data, when accessed, results in the machine performing:
providing the e-mail message to an e-mail server operable to distribute the e-mail message to the modified distribution list.

14. The article of claim 12 wherein the machine-accessible media further includes data, when accessed, results in the machine performing:
applying the subtractive list to the pre-determined distribution list to determine the modified distribution list; and
distributing the e-mail message to the modified distribution list.

15. The article of claim 12, wherein the e-mail message is distributed via an e-mail server, and wherein the machine-accessible media further includes data, when accessed, results in the machine performing:
submitting at least an indicator of the pre-determined distribution list and of the subtractive list to the e-mail server so that the e-mail server may determine the modified distribution list; and
receiving from the e-mail server data to facilitate distributing the e-mail message to the modified distribution list.

16. The article of claim 15 wherein the machine-accessible media further includes data, when accessed, results in the machine performing:
receiving an indicator of the modified distribution list; and
automatically re-addressing the e-mail message to indicator of the modified distribution list, wherein the e-mail server is operable to distribute the e-mail message.

17. The article of claim 15 wherein the machine-accessible media further includes data, when accessed, results in the machine performing:
providing at least an identifier for the pre-determined distribution list and of the subtractive list to a list server operable to apply the subtraction list to the pre-determined distribution list to determine the modified distribution list; and
receiving data from the list server to facilitate performing said distributing the e-mail message to the modified distribution list.

18. An article comprising a machine-accessible media having associated data for distributing an e-mail message to selected ones of a pre-determined distribution list, wherein the data, when accessed, results in a machine performing:
receiving an e-mail message addressed to a first indicator for a pre-determined distribution list;
receiving a second indicator for a subtractive list, which when applied to the pre-determined distribution list, determines a modified distribution list comprising members of the pre-determined distribution list not present in the subtractive list; and
distributing the e-mail message to each member of the modified distribution list.

19. The article of claim 18 wherein the machine-accessible media further includes data, when accessed, results in the machine performing:
first identifying, based at least in part on the first indicator, the members of the pre-determined distribution list;
second identifying, based at least in part on the second indicator, the members of the subtraction list; and
determining the modified distribution list based at least in part on membership of the pre-determined list and the subtraction list.
